(19) United States
(12) Patent Application Publication
(10) Pub. No.: US 2007/0216217 A1
(43) Pub. Date: Sep. 20, 2007

(54) Tow harness for vehicle equipped with electric brakes

(75) Inventors: Warren Clark, Evans, GA (US); Oliver A. Bell, Aiken, SC (US); Aric Singletary, Hephzibah, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/376,686

(22) Filed: Mar. 15, 2006

(51) Int. Cl. B60T 7/20

(52) U.S. Cl. 303/20; 188/3 R

(57) ABSTRACT

A tow harness is provided that that spans between connectors of respective towing and towed vehicles. The tow harness includes a first end that mates with the connector of the tow vehicle and includes a first jumper for completing a brake control circuit between a brake of the tow vehicle and a brake signal source of the tow vehicle. A second end mates with the connector of the towed vehicle and includes a second jumper that completes the brake control circuit between the brake signal source of the towing vehicle and a brake of the towed vehicle. In other embodiments a brake system includes an electric brake that includes inputs for a brake control signal. A brake controller receives power from a battery and generates the brake control signal. An electrical connector includes signal terminals connected to the brake control signal and power terminals connected to the battery.

### FIELD

The present disclosure relates generally to brake control systems for vehicles that are connected for towing.

### BACKGROUND

Utility vehicles, such as golf cars and other off-highway vehicles, are often used to pull trailers and other implements. In some cases, such as with rented golf cars, the vehicles can be used to tow each other so that they can be gathered quickly for cleaning, recharging, maintenance, and/or refueling. In such cases, the towed vehicle is generally placed in a neutral gear with the brakes released and the towing vehicle provides the braking energy for itself and the towed vehicle. While this provides a method of towing, there remains a need in the art for a simple and economical means for applying the brakes on the towed vehicle.

Also, some utility vehicles include electric brakes that provide braking energy when power is removed from the brake assembly. Towing such a vehicle presents a problem if the vehicle has a dead battery and/or a brake control circuit is malfunctioning and will not release the brakes. There remains a need in the art for a simple and economical method for releasing the electric brakes in a vehicle.

### SUMMARY

A tow harness is provided that that spans between connectors of respective towing and towed vehicles. The tow harness includes a first end that mates with the connector of the tow vehicle and includes a first jumper for completing a brake control circuit between a brake of the tow vehicle and a brake signal source of the tow vehicle. A second end mates with the connector of the towed vehicle and includes a second jumper that completes the brake control circuit between the brake signal source of the towing vehicle and a brake of the towed vehicle.

In other features, a brake system is provided for a vehicle. The brake system includes at least one brake for slowing the vehicle and including a control input for receiving a brake control signal. A brake control signal source generates the brake control signal that actuates the at least one brake and thereby provides a desired degree of braking. A connector is in series with the control input and the brake control signal. A jumper mates with the connector and connects the brake control signal to the control input.

A brake system is provided for a vehicle. The brake system includes an electric brake that includes inputs for a brake control signal. A brake controller receives power from a battery and generates the brake control signal. An electrical connector includes signal terminals connected to the brake control signal and power terminals connected to the battery.

In other features, the signal terminals and power terminals are insulated from each other. The power terminals connect across a fraction of the battery voltage. A wire harness includes a first end that mates with the connector. A second electric brake includes inputs for a second control signal and a second electrical connector includes signal terminals connected to the inputs of the second electric brake. The wire harness includes a second end that mates with the second connector. The battery provides the second signal through the wire harness to disable the second electric brake.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a schematic diagram of a utility vehicle that includes a first improved brake control system;

FIG. 2 is a schematic diagram of two utility vehicles that are connected for towing and each include the improved brake control system of FIG. 1;

FIG. 3 is a schematic diagram of a utility vehicle that includes a second improved brake control system; and

FIG. 4 is a schematic diagram of two utility vehicles that are connected for towing and each include the improved brake control system of FIG. 3.

### DETAILED DESCRIPTION OF THE VARIOUS EMBODIMENTS

The following description of various embodiments is merely exemplary in nature and is in no way intended to limit the present teachings, application, or uses. Throughout this specification, like reference numerals will refer to similar elements.

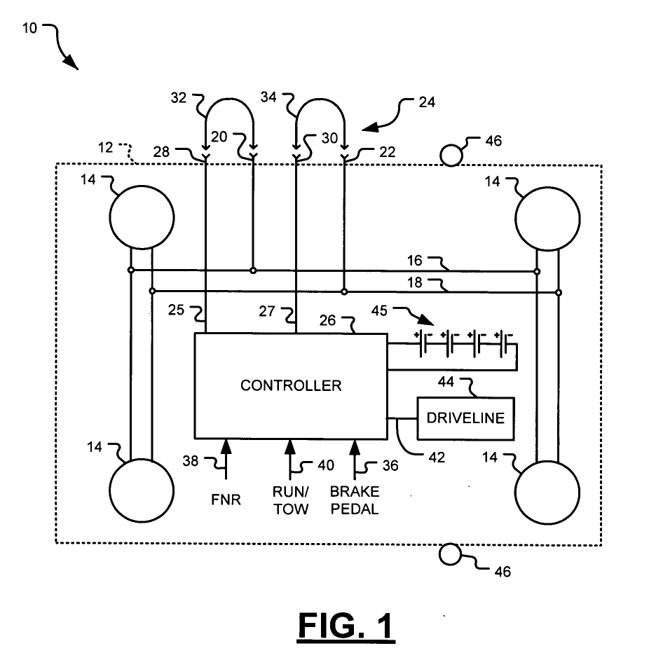

FIG. 1 shows a schematic diagram of one of various embodiments of braking system 10. Braking system 10 can be included in a utility vehicle that is represented by a dashed box 12. Braking system 10 connects to another braking system 10 of a towed vehicle and controls the brakes of both vehicles. Braking system 10 also automatically applies the brakes on the towed vehicle if it becomes disconnected from vehicle 12.

Vehicle 12 includes at least one electromagnetic spring-applied brake 14 that decreases braking power as electrical power provided to it is increased. These types of brakes are known to those skilled in the art and available from Stromag, Inc., Warner Electric, Inc., and The Lenze Corp., among other sources. In some embodiments, vehicle 12 includes one brake 14 for each wheel of vehicle 12. In other embodiments, vehicle 12 can include one electric brake per axle (not shown).

Each brake 14 includes a first 16 and a second 18 input for receiving a brake control signal. First and second inputs 16, 18 for each brake 14 connect in parallel with respective first and second brake input terminals 20, 22 of a connector 24. A controller 26 generates the brake control signal across outputs 25 and 27, which connect to respective first and second brake output terminals 28, 30 of connector 24. A first removable jumper 32 connects first output terminal 28 to first input terminal 20. A second removable jumper 34 connects second output terminal 30 to second input terminal 22. First and second removable jumpers 32, 34 can be part of a plug assembly that mates with connector 24.

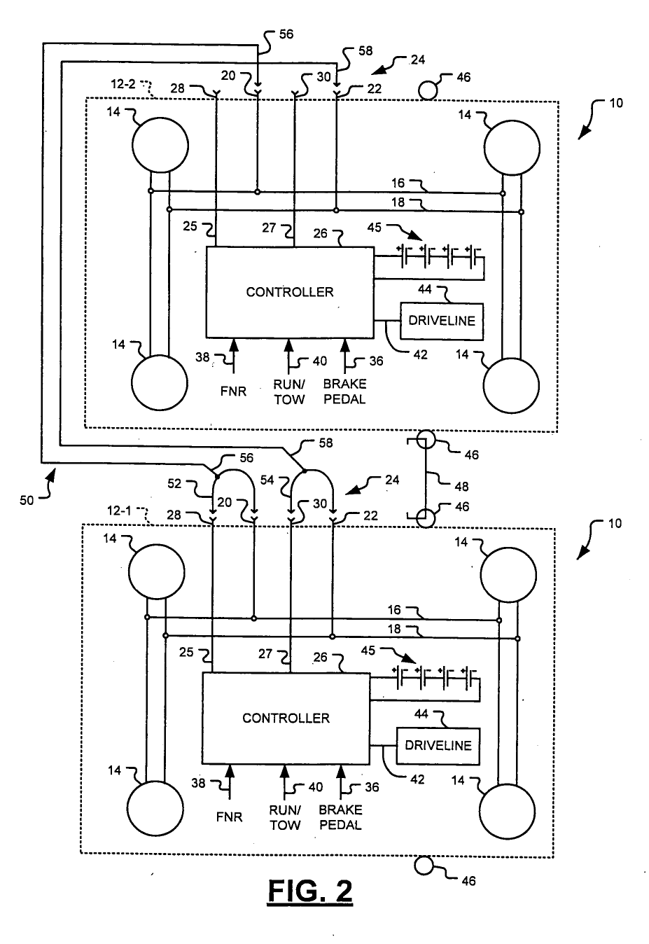

First and second removable jumpers 32, 24 plug into connector 24 when vehicle 12 is configured to be driven alone (i.e. not used as a towing vehicle). When vehicle 12 is configured to be used as a tow vehicle or configured to be towed, first and second removable jumpers 32, 34 are removed and replaced with one end of a tow harness 50 (FIG. 2). Tow harness 50 allows brakes 14 of the towed vehicle to be controlled by controller 26 of the towing vehicle as described below.

Controller 26 receives a brake pedal signal 36 that indicates a desired degree of braking. In some embodiments, brake pedal signal 36 is generated by a brake pedal position sensor that is connected to a brake pedal of vehicle 12. Controller 26 generates the brake control signal based on brake pedal signal 36 such that brakes 14 provide the desired degree of braking. In some embodiments, the brake control signal is a pulse-width modulated (PWM) signal.

Controller 26 also receives a forward/reverse/neutral (FNR) signal 38 and a run/tow signal 40. FNR signal 38 indicates a selected position of a gear shift lever of vehicle 12. Run/tow signal 40 indicates a selected position of a run/tow switch of vehicle 12.

In some embodiments, controller 26 generates a driveline control signal 42 that is based on FNR signal 38 and run/tow signal 40. Driveline control signal 42 is applied to a driveline 44 that selectively provides torque to the driving wheels of vehicle 12. Driveline control signal 42 determines whether driveline 44 is in a forward, neutral, or reverse condition. In some embodiments, driveline 44 can include a transmission. In other embodiments, driveline 44 can be implemented by controlling the speed and/or torque of one or more electric motors that are connected to respective drive wheels. A battery 45 can be used to provide power for the electric motor(s). Driveline control signal 42 can be eliminated when driveline 44 is shifted by other means, such as a mechanical linkage from the FNR lever.

When vehicle 12 is to be driven, either alone or as a towing vehicle, run/tow signal 40 indicates a run condition and FNR signal 38 indicates the selected gear shift lever position. Driveline control signal 42 then controls driveline 44 in accordance with FNR signal 38. When vehicle 12 is to be towed, run/tow signal 40 indicates a tow condition. Driveline control signal 42 then places driveline 44 in a neutral condition.

Vehicle 12 includes one or more attachment points 46 for a drawbar 48 (FIG. 2) that connects vehicles 12 for towing. Attachment points 46 can include a hitch ball, hitch receiver, and/or hitch pin that pivotally connects to the drawbar 42.

FIG. 2 shows one of various embodiments of a pair of vehicles 12-1 and 12-2 that are connected for towing. First vehicle 12-1 is configured as the towing vehicle and second vehicle 12-2 is configured as the vehicle being towed. Draw bar 48 pivotally connects attachment points 46 of respective vehicles 12-1 and 12-2.

A tow harness 50 includes a first end that connects to connector 24 of towing vehicle 12-1 and a second end that connects to connector 24 of towed vehicle 12-2. Connectors 24 can be conveniently located, such as under an instrument panel. Connectors 24 can also be combined with other connectors for supporting diagnostic communication with respective controllers 26. First end of tow harness 50 includes a first jumper 52 that connects first output terminal 28 to first input terminal 20. First end of tow harness 50 also includes a second jumper 54 that connects second output terminal 30 to second input terminal 22. A third jumper 56 connects between first jumper 52 and first input terminal 20 of towed vehicle 12-2. A fourth jumper 58 connects between second jumper 54 and second input terminal 22 of towed vehicle 12-2.

Operation of braking systems 10 will now be described for tow vehicle 12-1 and towed vehicle 12-2. In towing vehicle 12-1, run/tow signal 40 indicates a run condition and FNR signal 38 indicates the selected gear shift position. Driveline 44 therefore moves towing vehicle 12-1 in a direction based on FNR signal 38. Controller 26 of towing vehicle 12-1 generates the brake control signal across outputs 25 and 27 in accordance with brake pedal signal 36 of towing vehicle 12-1.

Jumpers 52 and 54 communicate the brake control signal to first and second inputs 16, 18 of brakes 14 in towing vehicle 12-1. Jumpers 56 and 58 communicate the brake control signal to first and second inputs 16, 18 of brakes 14 in towed vehicle 12-2.

In towed vehicle 12-2, run/tow signal 40 indicates a tow condition. Driveline 44 is therefore in a neutral condition that allows towed vehicle 12-2 to coast or freewheel. In some embodiments that include the electric motor in driveline 44, the neutral condition includes controlling the electric motor so that it motors towed vehicle 12-2 at the same speed as towing vehicle 12-1. Controller 26 can control the electric motor in such a manner by minimizing current flow though the electric motor regardless of whether it is motoring or regenerating. Controller outputs 25 and 27 of towed vehicle 12-2 are disconnected from brakes 14 of towed vehicle 12-2. The brake control signal for brakes 14 of towed vehicle 12-2 is instead provided through jumpers 56 and 58 that are plugged into connector 24 of towed vehicle 12-2. This allows brakes 14 of towed vehicle 12-2 to operate simultaneously with brakes 14 of towing vehicle 12-1.

Brake system 10 also provides emergency braking for towed vehicle 12-2 in the event it disconnects from towing vehicle 12-1. The length of tow harness 50 is selected to be equal to or somewhat greater than a length needed to reach between the connectors 24 of vehicles 12-1 and 12-2 when they are properly connected with draw bar 48. If towed vehicle 12-2 disconnects from towing vehicle 12-1 then towing harness 50 will necessarily unplug from one of vehicles 12-1 and 12-2. When towing harness 50 is unplugged it no longer provides the brake control signal to towed vehicle 12-2. Since brakes 14 are of a type that applies braking power when the brake control signal is removed, towed vehicle 12-2 automatically comes to a stop after towing harness 50 unplugs from one of vehicles 12-1 and 12-2.

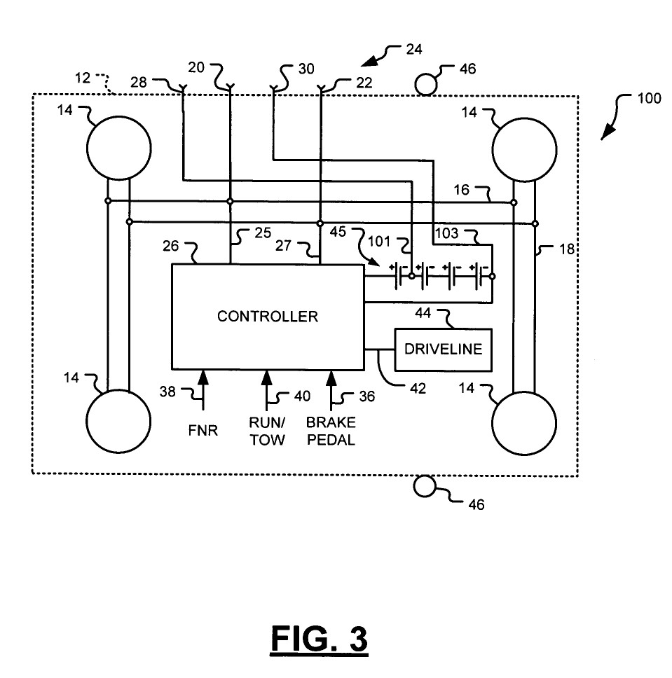

FIG. 3 shows a schematic diagram according to various embodiments of braking system 100. Braking system 100 can be included in vehicle 12. Braking system 100 connects to another braking system 100 of a towed vehicle and disables the brakes of the towed vehicle. When vehicle 12 is being towed braking system 100 automatically applies the brakes if vehicle 12 disconnects from the towing vehicle.

First and second inputs 16, 18 for each brake 14 connect to respective first and second brake input terminals 20, 22 of connector 24. Controller 26 generates the brake control signal across outputs 25 and 27, which connect to first and second inputs 16, 18 respectively. First output terminal 28 connects to a DC voltage terminal 101 of battery 45. Second output terminal 30 connects to a ground and/or a reference terminal 103 of battery 45. In some embodiments battery 45 is a 48V battery and terminal 101 provides a 36V tap from battery 45.

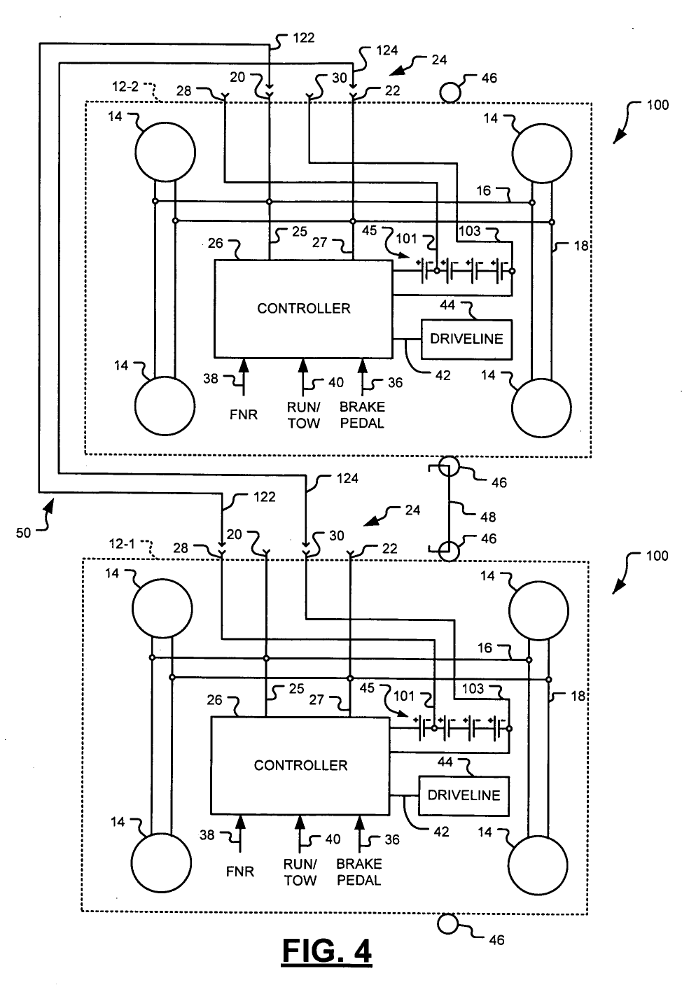

FIG. 4 shows various embodiments of a pair of vehicles 12-1 and 12-2 that are connected for towing. First vehicle 12-1 is configured as the towing vehicle and second vehicle 12-2 is configured as the vehicle being towed. Draw bar 48 pivotally connects attachment points 46 of respective vehicles 12-1 and 12-2.

A tow harness 120 includes a first conductor 122 and a second conductor 124. First conductor 122 connects first output terminal 28 of tow vehicle 12-1 to first brake input terminal 20 of towed vehicle 12-2. Second conductor 124 connects second output terminal 30 of tow vehicle 12-1 to second brake input terminal 22 of towed vehicle 12-2. These connections allow battery 45 of tow vehicle 12-1 to energize and thereby disable the brakes 14 of towed vehicle 12-2. Tow vehicle 12-2 can therefore be shifted into neutral and towed by tow vehicle 12-1.

Brake system 100 also provides emergency braking for towed vehicle 12-2 in the event it accidentally disconnects from towing vehicle 12-1. The length of tow harness 120 is selected to be equal to or somewhat greater than a length needed to reach between the connectors 24 of vehicles 12-1 and 12-2 when they are properly connected with draw bar 48. If towed vehicle 12-2 becomes separated from towing vehicle 12-1 then towing harness 120 will necessarily be pulled from one of vehicles 12-1 and 12-2. When towing harness 120 is unplugged it no longer provides battery power directly to brakes 14 of towed vehicle 12-2. Since brakes 14 are of a type that applies braking power when power is removed, towed vehicle 12-2 automatically comes to a stop after it becomes separated from towing vehicle 12-1.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A tow harness that spans between connectors of respective towing and towed vehicles, comprising:
a first end that mates with the connector of the tow vehicle and includes a first jumper for completing a brake control circuit between a brake of the tow vehicle and a brake signal source of the tow vehicle; and
a second end that mates with the connector of the towed vehicle and includes a second jumper that completes the brake control circuit between the brake signal source of the towing vehicle and a brake of the towed vehicle.

2. The tow harness of claim 1 wherein the first jumper and second jumper include a wire.

3. The tow harness of claim 1 wherein a length from the first end to the second end is equal to a length needed to reach between the connectors when the towing and towed vehicles are hitched together.

4. A brake system for a vehicle, comprising:
at least one brake for slowing the vehicle and including a control input for receiving a brake control signal;
a brake control signal source for generating the brake control signal that actuates the at least one brake and thereby provides a desired degree of braking;
a connector in series with the control input and the brake control signal; and
a jumper that mates with the connector and connects the brake control signal to the control input.

5. The brake system of claim 4 wherein the at least one brake includes an electromagnetic brake that provides braking energy when the brake control signal is removed from the electric brake.

6. The brake control system of claim 4 wherein the jumper includes a tow harness for communicating the brake control signal to a second vehicle.

7. The brake control system of claim 6 wherein the second vehicle includes at least one brake that receives the brake control signal and operates synchronously with the at least one brake of the vehicle.

8. The brake control system of claim 4 wherein the jumper includes a tow harness for communicating the brake control signal with a second vehicle and further comprising:
an electric motor that provides a driving force for the vehicle; and
a controller that receives a tow signal indicative of the utility vehicle being configured to be towed and that minimizes current flow through the electric motor when the tow signal is asserted.

9. A method for connecting braking systems of respective towing and towed vehicles, comprising:
completing a brake control circuit between a brake of the tow vehicle and a brake signal source of the tow vehicle; and
completing a brake control circuit between the brake signal source of the towing vehicle and a brake of the towed vehicle.

10. The method of claim 9 wherein the brake signal is electrical.

11. The method of claim 9 further comprising opening the brake control circuit between the brake signal source of the towing vehicle and the brake of the towed vehicle when a distance between the towing and towed vehicles exceeds a predetermined distance.

12. A method of braking a vehicle, comprising:
generating a brake control signal that represents a desired degree of braking;
routing the brake control signal to an output of a connector;
jumping the output to an input of the connector; and
routing the brake control signal from the input to at least one brake of the vehicle.

13. The method of claim 12 further comprising converting the brake control signal to an electromagnetic force.

14. The method of claim 12 wherein the jumping step includes communicating the brake control signal to a second vehicle.

15. The method of claim 14 further comprising braking the second vehicle based on the brake control signal.

16. The method of claim 12 wherein the jumping step includes communicating the brake control signal with a second vehicle and further comprising:
providing a driving force for the vehicle; and
receiving a tow signal indicative of the utility vehicle being configured to be towed and minimizing the driving force while the tow signal is asserted.

17. A tow harness that spans between connectors of respective towing and towed vehicles, comprising:
first end means for mating with the connector of the tow vehicle and including first jumper means for completing a brake control circuit between a brake of the tow vehicle and a brake signal source of the tow vehicle; and
a second end means for mating with the connector of the towed vehicle and including second jumper means for completing the brake control circuit between the brake signal source of the towing vehicle and a brake of the towed vehicle.

18. The tow harness of claim 17 wherein the first jumper means and second jumper means include a wire.

19. The tow harness of claim 17 wherein a length from the first end means to the second end means is equal to a length needed to reach between the connectors when the towing and towed vehicles are hitched together.

20. A brake system for a vehicle, comprising:
brake means for slowing the vehicle and including control input means for receiving a brake control signal;
source means for generating the brake control signal, which actuates the at least one brake and thereby provides a desired degree of braking;
connector means for providing access to the brake control signal and the control input means; and
jumper means for mating with the connector means and connecting the brake control signal to the control input means.

21. The brake system of claim 20 wherein the brake means includes electromagnetic brake means for providing braking energy when the brake control signal is removed from the control input means.

22. The brake control system of claim 20 wherein the jumper means includes tow harness means for communicating the brake control signal to a second vehicle.

23. The brake control system of claim 22 wherein the second vehicle includes brake means for receiving the brake control signal and braking the second vehicle synchronously with the brake means of the vehicle.

24. The brake control system of claim 20 wherein the jumper means includes tow harness means for communicating the brake control signal to a second vehicle and further comprising:
electric motor means for providing a driving force for the vehicle; and
controller means for receiving tow signal means for indicating the utility vehicle being configured to be towed and for minimizing current flow through the electric motor means based on the tow signal means.

25. A brake system for a vehicle, comprising:
an electric brake that includes inputs for a brake control signal;
a brake controller that receives power from a battery and generates the brake control signal; and
an electrical connector that includes signal terminals connected to the brake control signal and power terminals connected to the battery.

26. The brake system of claim 25 wherein the signal terminals and power terminals are insulated from each other.

27. The brake system of claim 25 wherein the power terminals connect across a fraction of the battery voltage.

28. The brake system of claim 25 further comprising a wire harness that includes a first end that mates with the connector.

29. The brake system of claim 28 further comprising:
a second electric brake that includes inputs for a second control signal; and
a second electrical connector that includes signal terminals connected to the inputs of the second electric brake, wherein the wire harness further includes a second end that mates with the second connector; and
wherein the battery provides the second signal through the wire harness to disable the second electric brake.

30. A method of braking a vehicle, comprising:
providing an electric brake that includes inputs for a brake control signal;
generating the brake control signal from battery power; and
providing voltage from the battery to an electrical connector.

31. The method of claim 30 further comprising isolating the battery power and the brake control signal.

32. The method of claim 30 wherein the voltage at the electrical connector is a fraction of the battery power voltage.

33. The method of claim 30 further comprising connecting a first end of a wire harness to the connector.

34. The method of claim 33 further comprising:
providing a second electric brake that includes inputs for a second control signal;
connecting the inputs of the second electric brake to a second electrical connector; and
connecting a second end of the wire harness to the second electrical connector such that the voltage provides the second control signal and disables the second electric brake.

35. A brake system for a vehicle, comprising:
electric brake means for receiving a brake control signal;
brake controller means for receiving power from a battery and generating the brake control signal; and
electrical connector means for connecting to the brake control signal and a voltage from the battery.

36. The brake system of claim 35 wherein the brake control signal and the voltage from the battery are insulated from each other.

37. The brake system of claim 35 wherein the voltage from the battery is a fraction of the power voltage.

38. The brake system of claim 35 further comprising wire harness means for mating with the connector.

39. The brake system of claim 38 further comprising:
second electric brake means for receiving a second control signal; and
second electrical connector means for mating with a second end of the wire harness and connecting the wire harness to the second control signal, wherein the voltage from the battery provides the second control signal to disable the second electric brake.
